(19) United States
(12) Patent Application Publication
(10) Pub. No.: US 2023/0419314 A1
(43) Pub. Date: Dec. 28, 2023

(54) SYSTEMS AND METHODS FOR MONITORING POST-TRANSACTION ADJUSTMENTS

(71) Applicant: Capital One Services, LLC, Mclean, VA (US)

(72) Inventors: Anne Moshyedi, Potomac, MD (US); Allison Trager, Demarest, NJ (US)

(21) Appl. No.: 17/851,568

(22) Filed: Jun. 28, 2022

(51) Int. Cl. G06Q 20/38; G06Q 20/40; G06N 20/00; G06Q 20/42

(52) U.S. Cl. CPC G06Q 20/389; G06Q 20/4014; G06Q 20/4015; G06Q 20/4016; G06N 20/00; G06Q 20/42

(57) ABSTRACT

Disclosed embodiments may include a system for monitoring post-transaction adjustments. The system may receive data associated with a transaction, and determine whether the transaction is indicative of a post-transaction event (PTE). The system may cause a user device to display, via a GUI, a notification to prompt a user to confirm the PTE occurred and to enter a post-transaction amount (PTA) associated with the PTE. The system may monitor the data to determine whether the data has been updated to include a second PTA, and if so, the system may determine whether the first and second PTAs match. When a match is determined, the system may confirm the transaction, modify the GUI to generate a modified GUI comprising a confirmation indication, and cause the user device to display the confirmation indication. When no match is determined, the system may initiate fraud prevention action(s).

The disclosed technology relates to systems and methods for monitoring post-transaction adjustments. Specifically, this disclosed technology relates to predicting and estimating payment adjustments after an initial transaction takes place.

### BACKGROUND

Many times, a transaction may require adjusting after an initial transaction takes place. For example, a customer sitting in a restaurant may add gratuity onto a meal receipt after his or her credit card has already been processed, a return shipping fee may be deducted from a returned charge upon an item being returned to a merchant, or a late fee may be applied to a customer's account for missing an obligatory payment or other action. Traditional systems and methods for conducting post-transaction adjustments typically require a plurality of steps be conducted and by multiple involved parties, such as customers, merchants, and/or financial institutions, increasing the complexity and burden of monitoring post-transaction adjustments.

Accordingly, there is a need for improved systems and methods for monitoring post-transaction adjustments. Embodiments of the present disclosure are directed to this and other considerations.

### SUMMARY

Disclosed embodiments may include a system for monitoring post-transaction adjustments. The system may include one or more processors, and memory in communication with the one or more processors and storing instructions that, when executed by the one or more processors, are configured to cause the system to provide monitoring of post-transaction adjustments. The system may receive data associated with a transaction conducted by a user. The system may determine, using a first machine learning model (MLM) and based on one or more factors, whether the transaction is indicative of a post-transaction event (PTE). Responsive to determining the transaction is indicative of the PTE, the system may cause a user device associated with the user to display a first notification, via a graphical user interface (GUI), to prompt the user to confirm that the PTE occurred and to enter a first post-transaction amount (PTA) associated with the PTE. The system may receive, from the user via the GUI, a confirmation that the PTE occurred and the first PTA. The system may monitor the data associated with the transaction to determine whether the data has been updated to include a second PTA. Responsive to determining the data has been updated to include the second PTA, the system may determine whether the first and second post-transaction amounts (PTAs) match. Responsive to determining the first and second PTAs match, the system may confirm the transaction, may modify the GUI to generate a first modified GUI comprising a confirmation indication, and may cause the user device to display the confirmation indication. Responsive to determining the first and second PTAs do not match, the system may initiate one or more fraud prevention actions.

Disclosed embodiments may include a system for monitoring post-transaction adjustments. The system may include one or more processors, and memory in communication with the one or more processors and storing instructions that, when executed by the one or more processors, are configured to cause the system to provide monitoring of post-transaction adjustments. The system may receive data associated with a transaction conducted by a user. The system may determine, using a first MLM and based on one or more factors, whether the transaction is indicative of a PTE. Responsive to determining the transaction is indicative of the PTE, the system may cause a user device associated with the user to display a first notification, via a GUI, to prompt the user to confirm the PTE occurred. The system may receive, from the user via the GUI, a confirmation of the PTE. Responsive to receiving the confirmation of the PTE, the system may determine, using a second MLM and based on the one or more factors, a first PTA. The system may monitor the data associated with the transaction to determine whether the data has been updated to include a second PTA. Responsive to determining the data has been updated to include the second PTA, the system may determine whether the second PTA matches the first PTA within a predetermined threshold. Responsive to determining the second PTA matches the first PTA within the predetermined threshold, the system may confirm the transaction, may modify the GUI to generate a first modified GUI comprising a confirmation indication, and may cause the user device to display the confirmation indication. Responsive to determining the second PTA does not match the first PTA within the predetermined threshold, the system may cause the user device associated with the user to display a second notification, via the GUI, to prompt the user to confirm the second PTA.

Disclosed embodiments may include a system for monitoring post-transaction adjustments. The system may include one or more processors, and memory in communication with the one or more processors and storing instructions that, when executed by the one or more processors, are configured to cause the system to provide monitoring of post-transaction adjustments. The system may receive data associated with a transaction conducted by a user. The system may determine, using a first MLM and based on one or more factors, that the transaction is indicative of a PTE. Responsive to determining the transaction is indicative of the PTE, the system may cause a user device associated with the user to display a first notification, via a GUI, to prompt the user to confirm the PTE occurred. The system may receive, from the user via the GUI, a confirmation of the PTE. Responsive to receiving the confirmation of the PTE, the system may determine, using a second MLM and based on the one or more factors, a first PTA associated with the PTE. The system may monitor the data associated with the transaction to determine whether the data has been updated to include a second PTA. Responsive to determining the data has been updated to include the second PTA, the system may cause the user device associated with the user to display a second notification, via the GUI, to prompt the user to confirm the second PTA. The system may receive, from the user via the GUI, a first indication that the second PTA is correct. Responsive to receiving the first indication, the system may confirm the transaction, may modify the GUI to generate a first modified GUI comprising a confirmation indication, and may cause the user device to display the confirmation indication. The system may receive, from the user via the GUI, a second indication that the second PTA is incorrect. Responsive to receiving the second indication, the system may initiate one or more fraud prevention actions.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for monitoring post-transaction adjustments in accordance with certain embodiments of the disclosed technology.

FIGS. 2A-2B are a flow diagram illustrating an exemplary method for monitoring post-transaction adjustments in accordance with certain embodiments of the disclosed technology.

FIG. 3 is block diagram of an example prediction system used to provide monitoring of post-transaction adjustments, according to an example implementation of the disclosed technology.

FIG. 4 is block diagram of an example system that may be used to provide monitoring of post-transaction adjustments, according to an example implementation of the disclosed technology.

### DETAILED DESCRIPTION

In situations where post-transaction adjustments are conducted, individuals, e.g., customers, may not always pay attention to each post-transaction adjustment made on an account, and hence may be unaware when mistakes are made, whether intentionally or unintentionally, by a merchant, a financial institution, or even the individuals themselves.

Accordingly, examples of the present disclosure relate to systems and methods for monitoring post-transaction adjustments. More particularly, the disclosed technology relates to determining whether a post-transaction adjustment may be made, estimating what that adjustment might be, and providing one or more fraud prevention actions in the event of any incorrect adjustments. For example, the disclosed technology may provide for predicting whether a certain transaction may be of the type that typically includes some form of post-transaction adjustment, and determining what amount that adjustment might be, based on, e.g., merchant information and/or historical transaction data. The disclosed technology may then provide for determining if and when a merchant has charged a customer with a post-transaction amount, and determining whether that charged post-transaction amount is at least within a predefined range of the predicted amount. The disclosed technology may provide for the performing of fraud prevention actions in response to determining the charged amount may be outside the allowable range, such as transmitting a notification to the customer to see if the customer would like to dispute the charged amount, and/or transmitting a notification to the merchant to see if the merchant can verify and/or adjust the charged amount.

Additionally, the disclosed technology may address problems regarding whether data entries describing a transaction may be finalized. For example, in some instances, a system may create an entry memorializing a transaction. Certain details of the transaction may, however, be later revised. For example, in the context of a data entry corresponding to a transaction with a restaurant, the total fee may change depending on the amount of a tip given by the customer. Disclosed embodiments may employ machine learning models (MLMs), among other computerized techniques, to preemptively determine whether data is finalized or whether it is likely to be subject to future updates. Machine learning models are a unique computer technology that involves training models to complete tasks and make decisions. These techniques may help to improve database and network operations.

For example, the systems and methods described herein may utilize, in some instances, MLMs, which are necessarily rooted in computers and technology, to determine whether a transaction is indicative of a post-transaction adjustment, and if so, estimate a value of that adjustment. This, in some examples, may involve using transaction, merchant, and/or time-based input data and a prediction and/or estimation type MLM, applied to predict the occurrence and/or value of a post-transaction adjustment, and output a reliable result for notification to an account holder. Using an MLM in this way may allow the system to notify a user of any adjustments made on an account, and to conduct fraud prevention measures in the event of an inaccurate adjustment. This is a clear advantage and improvement over prior technologies that require users to track transactions for any applied post-transaction adjustments, and are therefore prone to user error. The present disclosure solves this problem by providing real-time monitoring and notification regarding users' transactions.

The systems and methods described herein further utilize, in some instances, graphical user interfaces (GUIs), which are necessarily rooted in computers and technology. Graphical user interfaces are a computer technology that allows for user interaction with computers through touch, pointing devices, or other means. The present disclosure details modifying GUIs of user mobile devices based on monitored post-transaction adjustments, and causing the mobile devices to display the modified GUIs. This, in some examples, may involve using post-transaction adjustment data to dynamically change the GUI so that the GUI provides a user with an indication as to whether a post-transaction adjustment was accurate. Using a GUI in this way may allow the system to provide results of real-time post-transaction adjustment data monitoring to users via mobile devices. This is a clear advantage and improvement over prior technologies that require users to manually track these types of adjustments because these prior technologies are prone to user error. The present disclosure solves this problem by providing a variety of different types of automatic notifications to users based on whether the system determines a post-transaction adjustment to fall within an allowable threshold.

Furthermore, examples of the present disclosure may also improve the speed with which computers can track transaction adjustments and provide notifications to users of such adjustments. Overall, the systems and methods disclosed have significant practical applications in the transaction monitoring field because of the noteworthy improvements of adjustment estimation, user notification, and automatic fraud prevention measures, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

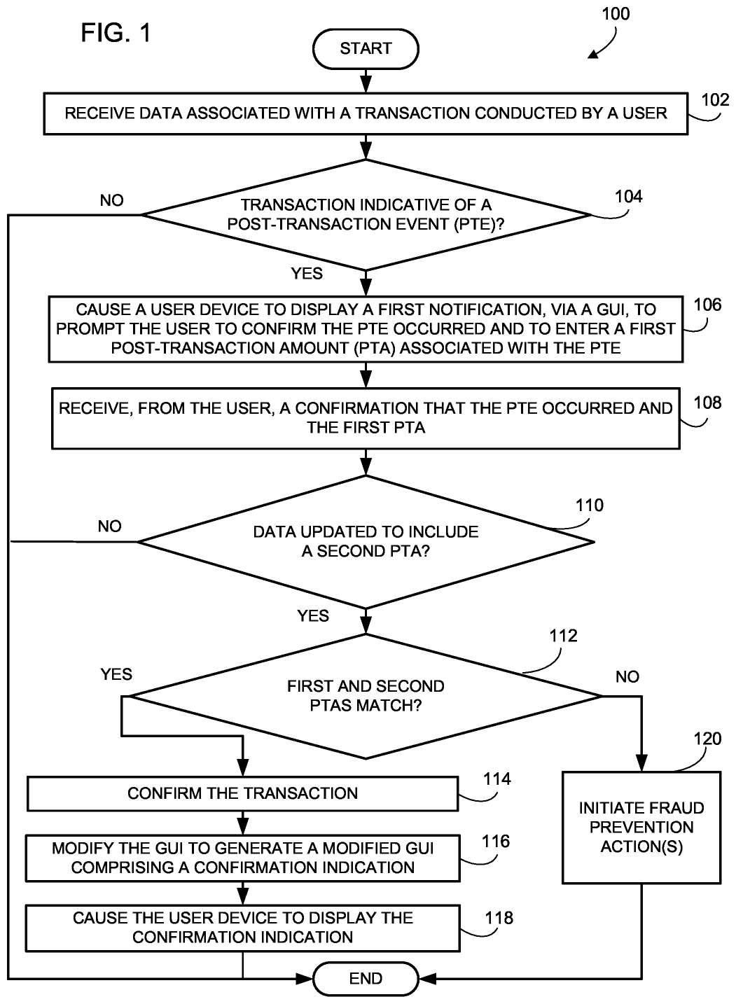

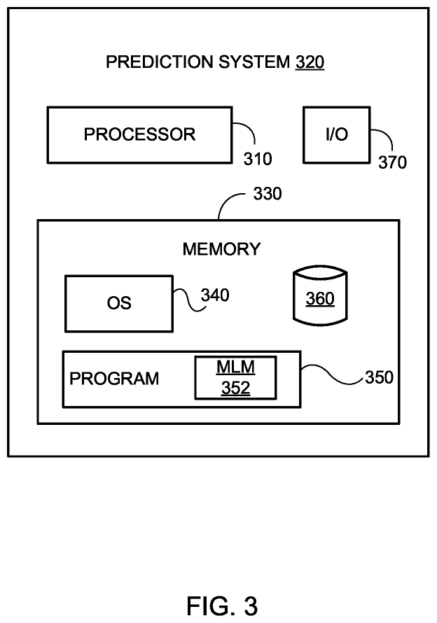

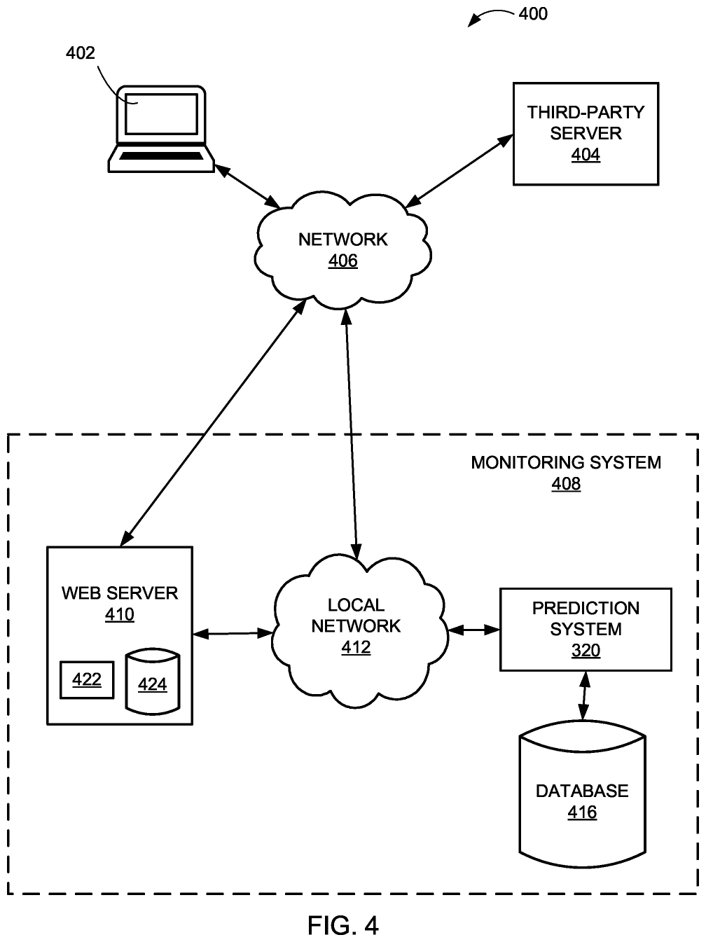

FIG. 1 is a flow diagram illustrating an exemplary method 100 for monitoring post-transaction adjustments, in accordance with certain embodiments of the disclosed technology. The steps of method 100 may be performed by one or more components of the system 400 (e.g., prediction system 320 or web server 410 of monitoring system 408 or user device 402), as described in more detail with respect to FIGS. 3 and 4.

In block 102, the prediction system 320 may receive data associated with a transaction conducted by a user. The data may include, for example, a date, time, entity (e.g., merchant) name, entity classification (e.g., merchant category code (MCC)), entity type, geographic location, amount, payment method (e.g., credit card number, account number, etc.), or any other information pertaining to a user-conducted transaction. In some embodiments, the prediction system 320 may be owned and/or operated by a financial institution that may receive the data when the user, for example, conducts the transaction using an account (e.g., a credit card) associated with the financial institution.

In block 104, the prediction system 320 may determine, using a first MLM and based on one or more factors, whether the transaction is indicative of a PTE. The one or more factors may include, for example, transaction history of the specific user and/or other users, an entity classification (e.g., an MCC), an entity type, a geographic location, a time of day, and the like. For example, the first MLM may evaluate that the transaction was conducted in the evening time, and likely at a restaurant given the merchant's name and/or MCC. The first MLM may also review the user's past transaction history to see that this user has conducted transactions with the same or a similar MCC in the past. Based on evaluating these factors, the MLM may predict that this transaction was likely for food and/or drinks at a restaurant, and hence the user may likely be interested in leaving a tip or gratuity after providing initial payment to the merchant.

In some embodiments, rather than automatically implementing a trained MLM, the prediction system 320 (or another component of monitoring system 408) may be configured to first cause a user device associated with the user to display, via a GUI, a notification or other message informing the user that a transaction has been made. The user may then be able to open the notification via his/her device (e.g., via a mobile application) and flag the notification, for example via a selectable user object, to request prediction system 320 monitor this particular transaction. The user may also be able to enter into the notification an expected dollar amount value that may or should be applied to this particular transaction. In some embodiments, the user may have the ability to enter, e.g., via a user profile of a mobile application, preferences for receiving such notifications. For example, the user may prefer to only be notified of transactions above a certain dollar amount, or from specific merchants.

In block 106, responsive to determining the transaction is indicative of a PTE, the prediction system 320 may cause a user device associated with the user to display a first notification (e.g., a push notification), via a GUI, to prompt the user to confirm that the PTE occurred and to enter a first PTA associated with the PTE. The first notification may be displayed via, e.g., a mobile application on the user's device. The prompt may include one or more selectable objects and/or fields such that the user may indicate (e.g., by typing into a data field, selecting from a drop-down menu, etc.) whether the user did in fact add a PTA to this transaction (e.g., left a tip after paying for a restaurant meal). The user may also be able to enter or select, via the GUI, the value or dollar amount of the PTA. For example, if the user remembers about how much tip he/she left at the restaurant, he/she can enter that dollar amount into the prompt via the GUI.

In block 108, the prediction system 320 may receive, from the user via the GUI, a confirmation that the PTE occurred and the first PTA. As discussed above (block 106), the prediction system 320 may receive the user's selections and/or inputs confirming the PTE took place and/or the dollar amount of the PTA.

In some embodiments, the prediction system 320 may determine, using a second MLM and based on the one or more factors (e.g., as discussed in block 104), whether the first PTA received from the user exceeds a predetermined threshold. The predetermined threshold may be, for example, previously customized by the user (e.g., what range of gratuity the user prefers to leave for restaurant meals of specific values), or determined by the second MLM based on, e.g., how much the user or other users tend to add onto payment from certain merchants, at certain times of day, in certain geographic locations, etc. Responsive to determining the first PTA exceeds the predetermined threshold, the prediction system 320 may be configured to cause the user device to display, via a GUI, a notification indicating the first PTA may be higher (or lower) than the user desires for this type of transaction.

In block 110, the prediction system 320 may monitor the data associated with the transaction to determine whether the data has been updated to include a second PTA. That is, the prediction system 320 may be configured to continuously monitor new and/or updated transactions associated with the user to determine if and when the transaction-in-question is changed or updated in any way, such as by the corresponding merchant. For example, the prediction system 320 may monitor the transaction-in-question to determine if and when the total transaction, or charged amount, increases (e.g., by the merchant adding the user's selected tip/gratuity onto the final payment).

In block 112, responsive to determining the data has been updated to include the second PTA, the prediction system 320 may determine whether the first and second PTAs match. That is, if the prediction system 320 previously received the user's selected dollar amount of the PTA, or estimated the first PTA itself via a second MLM (block 108), the prediction system 320 may be configured to compare that dollar amount (i.e., the first PTA) to the later-added dollar amount (i.e., the second PTA) to make sure they match. Determining whether the first and second PTAs match may include determining whether they fall within a predetermined threshold of one another, for example, a percentage (e.g., 2%, 5%, 7%, etc.) or dollar amount (e.g., $2, $5, $10, etc.). This predetermined threshold may be set as a default threshold by the prediction system 320 (or another component of monitoring system 408), or may be customized by the user. The benefit of the prediction system 320 making this comparison is to ensure, for example, the merchant hasn't incorrectly added the gratuity amount onto the user's final bill (e.g., if the user left a $10 tip, but the merchant accidentally entered $100).

In block 114, responsive to determining the first and second PTAs match, the prediction system 320 may confirm the transaction. For example, the prediction system 320 (or other component of monitoring system 408) may receive a request from the merchant to authorize the second PTA on top of the initially charged payment amount. Upon determining a match between the first and second PTAs, the prediction system 320 may confirm the total transaction amount and transmit a payment authorization to the merchant.

In block 116, further responsive to determining the first and second PTAs match, the prediction system 320 may modify the GUI to generate a first modified GUI comprising a confirmation indication. That is, the prediction system 320 may be configured to modify the GUI of the user's device (block 106) to display some form of confirmation indication, such as a green flag, a bolded text, etc., proximate the transaction record, such that the user may see a visual change to the GUI to indicate this transaction was approved and confirmed.

In block 118, further responsive to determining the first and second PTAs match, the prediction system 320 may cause the user device to display the confirmation indication, as discussed above.

Alternatively, in block 120, responsive to determining the first and second PTAs do not match, the prediction system 320 may initiate one or more fraud prevention activities. That is, upon determining the first and second PTAs do not match, or are at least outside some predetermined threshold, as discussed above, the prediction system 320 may be configured to perform one or more actions to ensure the user is not incorrectly charged. In some embodiments, the one or more fraud prevention actions may include transmitting a notification to the merchant associated with the transaction. The notification may alert the merchant to the fact that an incorrect charge may have been applied to the user's bill such that the merchant can confirm or adjust the applied second PTA. In some embodiments, the prediction system 320 may receive a response from the merchant, for example, indicating the merchant has adjusted the applied second PTA. Responsive to receiving such response, the prediction system 320 may be configured to modify a GUI to generate a modified GUI including an indication that the merchant has adjusted the second PTA and/or the amount of the second PTA adjusted value. Prediction system 320 may cause a user device (e.g., associated with the user) to display the modified GUI. For example, as discussed above, prediction system 320 may be configured to modify the GUI of the user's device to display some form of adjustment indication, such as a plus or minus sign, an exclamation mark, etc., proximate the transaction record, such that the user may see a visual change to the GUI to indicate this transaction has been adjusted.

In some embodiments, the one or more fraud prevention actions may include causing the user device associated with the user to display a notification, via the GUI, to request whether the user would like to dispute the transaction. For example, prediction system 320 (and monitoring system 408) may be owed and/or operated by a financial institution that may be capable of placing the potential charge in a “pending” status until the charge can be confirmed. In some cases, the financial institution may reach out directly to the merchant and/or the customer. In some cases, the financial institution may, as a default or depending on the specific user, cancel the charge altogether, trusting the user's word that the charge is incorrect. In some embodiments, the prediction system 320 may receive, from the user via the GUI, a response to the notification indicating the user would like to dispute the transaction. Responsive to receiving such response, the prediction system 320 may modify the GUI to generate a modified GUI including a disputed indication, and cause the user device to display such indication. That is, as discussed above, prediction system 320 may be configured to modify the GUI of the user's device to display some form of disputed indication, such as a yellow flag, an underlined text, etc., proximate the transaction record, such that the user may see a visual change to the GUI to indicate this transaction is in a disputed state.

In some embodiments, responsive to determining the first and second PTAs do not match, the prediction system 320 may cause the user device associated with the user to display a notification, via the GUI, to request the user confirm the second PTA. The prediction system 320 may receive, from the user via the GUI, an indication (e.g., via the user selecting a user input object or responding to a prompt) that the second PTA is incorrect. In response to receiving such indication, the prediction system 320 may be configured to modify the GUI to generate a modified GUI including an incorrect confirmation indication (e.g., a red flag, bolded text, etc.) such that the user may see a visual change to the GUI to indicate this transaction is potentially incorrect. In some embodiments, the prediction system 320 may be configured to initiate the one or more fraud prevention actions, as discussed above, in response to receiving the indication from the user that the second PTA is incorrect.

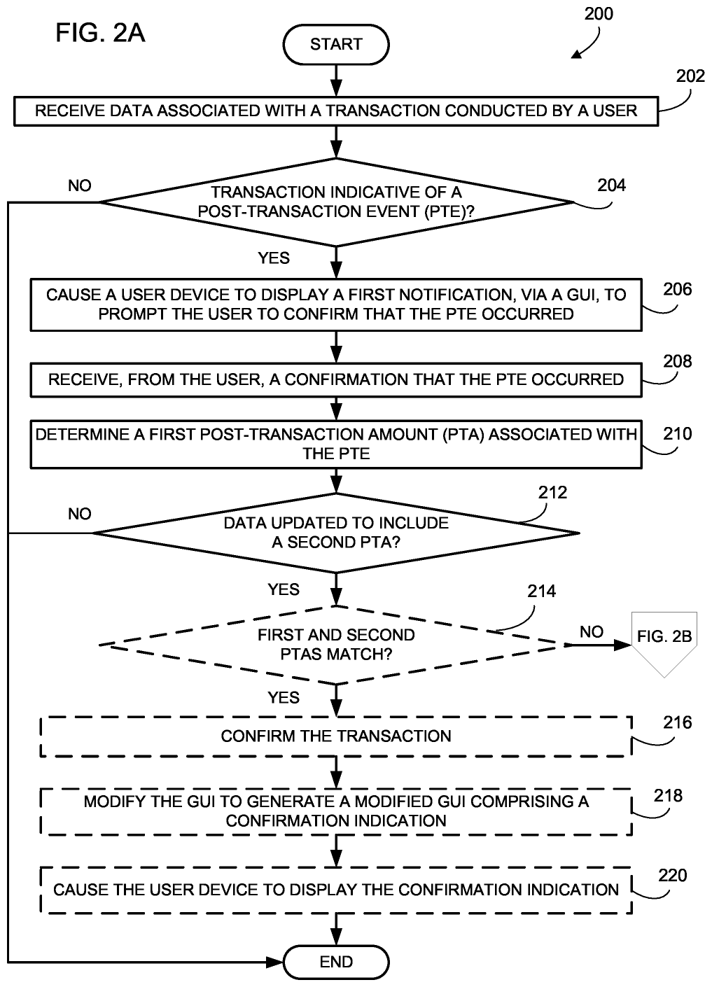

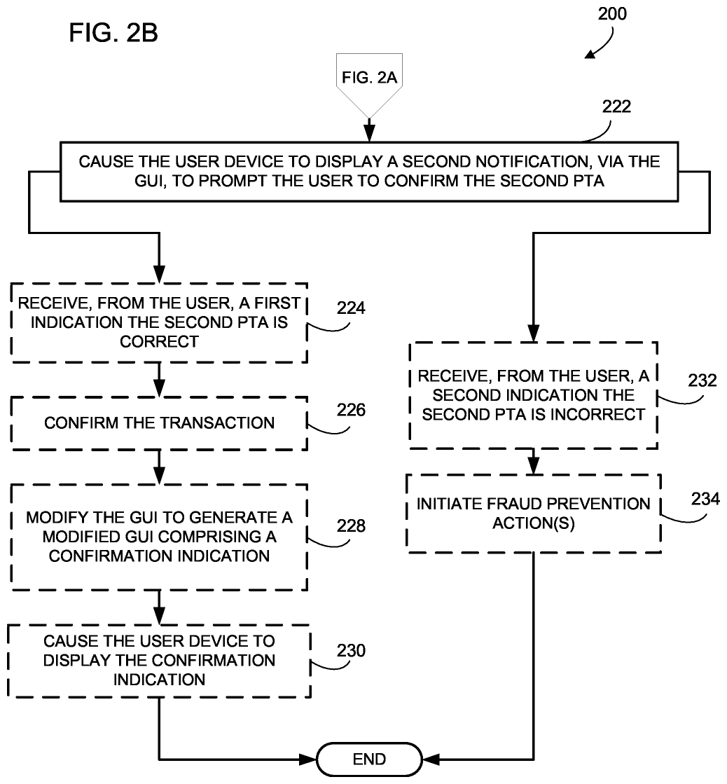

FIGS. 2A-2B are a flow diagram illustrating an exemplary method 200 for monitoring post-transaction adjustments, in accordance with certain embodiments of the disclosed technology. The steps of method 200 may be performed by one or more components of the system 400 (e.g., prediction system 320 or web server 410 of monitoring system 408 or user device 402), as described in more detail with respect to FIGS. 3 and 4.

Method 200 of FIGS. 2A-2B is similar to method 100 of FIG. 1, except that method 200 may not include certain features within blocks 106 and 108, and may include the use of an additional MLM. The descriptions of blocks 202, 204, 212, 214, 216, 218, 220, 226, 228, 230, and 234 in method 200 may be the same as or similar to the respective descriptions of blocks 102, 104, 110, 112, 114, 116, 118, 114, 116, 118, and 120 of method 100 and are not repeated herein for brevity. However, blocks 206 and 208 are different from blocks 106 and 108 and are described below, as well as additional blocks 210, 222, 224, and 232.

In block 206, responsive to determining the transaction is indicative of the PTE, the prediction system 320 may cause a user device associated with the user to display a first notification, via a GUI, to prompt the user to confirm that the PTE occurred. This step may be the same as or similar to block 106 of FIG. 1; however, this step may not include prompting the user to enter a first PTA associated with the PTE. Instead, prediction system 320 may cause the user device to prompt the user only to confirm that the transaction-in-question should in fact include a post-transaction adjustment.

In block 208, the prediction system 320 may receive, from the user via the GUI, a confirmation that the PTE occurred. This step may be the same as or similar to block 108 of FIG. 1; however, this step may not include receiving the first PTA from the user. Instead, prediction system 320 may only receive from the user a confirmation that the transaction-in-question should include a post-transaction adjustment.

In block 210, responsive to receiving the confirmation of the PTE, the prediction system 320 may determine, using a second MLM and based on the one or more factors (e.g., as in block 204), a first PTA. That is, rather than receiving the first PTA from the user, as in method 100 of FIG. 1, method 200 involves the use of a second MLM to determine what the value of the first PTA might be. For example, the second MLM may be trained to factor into its estimation the user's transaction history in general and/or at the particular merchant associated with the transaction, and the user's geographic location. As such, the second MLM may be able to generate at least an approximate range, e.g., of how much gratuity a user may leave at a restaurant (e.g., between 16-22%).

In block 222, responsive to determining the first and second PTAs do not match, the prediction system 320 may cause the user device associated with the user to display a second notification, via the GUI, to prompt the user to confirm the second PTA. As discussed above, determining whether the first and second PTAs match may include determining whether the two values are at least within a predetermined threshold of each other (block 112).

In block 224, the prediction system 320 may receive, from the user via the GUI, a first indication that the second PTA is correct. This first indication may be received in a form similar to those indications discussed above. In response to receiving such indication, the prediction system 320 may initiate one or more actions disclosed herein, such as confirming the transaction (blocks 114, 226), modifying the GUI to generate a modified GUI comprising a confirmation indication (blocks 116, 228), and/or causing the user device to display the confirmation indication (blocks 118, 230).

In block 232, the prediction system 320 may receive, from the user via the GUI, a second indication that the second PTA is incorrect. This second indication may be received in a form similar to those indications discussed above. In response to receiving such indication, the prediction system 320 may initiate one or more actions disclosed herein, such as one or more fraud prevention actions (blocks 120, 234).

FIG. 3 is a block diagram of an example prediction system 320 used to predict whether a transaction is indicative of a post-transaction adjustment, and/or what value that adjustment might be, according to an example implementation of the disclosed technology. According to some embodiments, the user device 402 and web server 410, as depicted in FIG. 4 and described below, may have a similar structure and components that are similar to those described with respect to prediction system 320 shown in FIG. 3. As shown, the prediction system 320 may include a processor 310, an input/output (I/O) device 370, a memory 330 containing an operating system (OS) 340 and a program 350. In some embodiments, program 350 may include an MLM 352 that may be trained, for example, to determine whether a transaction is indicative of a post-transaction adjustment, and if so, what the value of that adjustment might be. In certain implementations, MLM 352 may issue commands in response to processing an event, in accordance with a model that may be continuously or intermittently updated. Moreover, processor 310 may execute one or more programs (such as via a rules-based platform or the trained MLM 352), that, when executed, perform functions related to disclosed embodiments.

In certain example implementations, the prediction system 320 may be a single server or may be configured as a distributed computer system including multiple servers or computers that interoperate to perform one or more of the processes and functionalities associated with the disclosed embodiments. In some embodiments prediction system 320 may be one or more servers from a serverless or scaling server system. In some embodiments, the prediction system 320 may further include a peripheral interface, a transceiver, a mobile network interface in communication with the processor 310, a bus configured to facilitate communication between the various components of the prediction system 320, and a power source configured to power one or more components of the prediction system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™ low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the prediction system 320 may include one or more storage devices configured to store information used by the processor 310 (or other components) to perform certain functions related to the disclosed embodiments. In one example, the prediction system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The prediction system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the prediction system 320 may include the memory 330 that may include one or more programs 350 to perform one or more functions of the disclosed embodiments. For example, in some embodiments, the prediction system 320 may additionally manage dialogue and/or other interactions with the customer via a program 350.

The processor 310 may execute one or more programs 350 located remotely from the prediction system 320. For example, the prediction system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a prediction system database 360 for storing related data to enable the prediction system 320 to perform one or more of the processes and functionalities associated with the disclosed embodiments.

The prediction system database 360 may include stored data relating to status data (e.g., average session duration data, location data, idle time between sessions, and/or average idle time between sessions) and historical status data. According to some embodiments, the functions provided by the prediction system database 360 may also be provided by a database that is external to the prediction system 320, such as the database 416 as shown in FIG. 4.

The prediction system 320 may also be communicatively connected to one or more memory devices (e.g., databases) locally or through a network. The remote memory devices may be configured to store information and may be accessed and/or managed by the prediction system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The prediction system 320 may also include one or more I/O devices 370 that may comprise one or more interfaces for receiving signals or input from devices and providing signals or output to one or more devices that allow data to be received and/or transmitted by the prediction system 320. For example, the prediction system 320 may include interface components, which may provide interfaces to one or more input devices, such as one or more keyboards, mouse devices, touch screens, track pads, trackballs, scroll wheels, digital cameras, microphones, sensors, and the like, that enable the prediction system 320 to receive data from a user (such as, for example, via the user device 402).

In examples of the disclosed technology, the prediction system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The prediction system 320 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another MLM. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The prediction system 320 may be configured to adjust model parameters during training. Model parameters may include weights, coefficients, offsets, or the like. Training may be supervised or unsupervised.

The prediction system 320 may be configured to train MLMs by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The prediction system 320 may be configured to optimize statistical models using known optimization techniques.

Furthermore, the prediction system 320 may include programs configured to retrieve, store, and/or analyze properties of data models and datasets. For example, prediction system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other MLM.

The prediction system 320 may include algorithms to determine a data type, key-value pairs, row-column data structure, statistical distributions of information such as keys or values, or other property of a data schema may be configured to return a statistical profile of a dataset (e.g., using a data-profiling model). The prediction system 320 may be configured to implement univariate and multivariate statistical methods. The prediction system 320 may include a regression model, a Bayesian model, a statistical model, a linear discriminant analysis model, or other classification model configured to determine one or more descriptive metrics of a dataset. For example, prediction system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The prediction system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, prediction system 320 may be configured to generate a similarity metric representing a measure of similarity between data in a dataset. A similarity metric may be based on a correlation, covariance matrix, a variance, a frequency of overlapping values, or other measure of statistical similarity.

The prediction system 320 may be configured to generate a similarity metric based on data model output, including data model output representing a property of the data model. For example, prediction system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The prediction system 320 may be configured to classify a dataset. Classifying a dataset may include determining whether a dataset is related to another dataset(s). Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The prediction system 320 may include one or more data classification models to classify datasets based on the data schema, statistical profile, and/or edges. A data classification model may include a convolutional neural network, a random forest model, a recurrent neural network model, a support vector machine model, or another MLM. A data classification model may be configured to classify data elements as actual data, synthetic data, related data, or any other data category. In some embodiments, prediction system 320 is configured to generate and/or train a classification model to classify a dataset, consistent with disclosed embodiments.

The prediction system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via weighted connections. Prediction models may additionally or alternatively include classification and regression trees, or other types of models known to those skilled in the art. To generate prediction models, the prediction system may analyze information applying machine-learning methods.

While the prediction system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the prediction system 320 may include a greater or lesser number of components than those illustrated.

FIG. 4 is a block diagram of an example system that may be used to view and interact with monitoring system 408, according to an example implementation of the disclosed technology. The components and arrangements shown in FIG. 4 are not intended to limit the disclosed embodiments as the components used to implement the disclosed processes and features may vary. As shown, monitoring system 408 may interact with a user device 402 via a network 406. In certain example implementations, the monitoring system 408 may include a local network 412, a prediction system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the monitoring system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the monitoring system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi™ networks. In some embodiments, the network 406 may connect terminals, services, and mobile devices using direct connections such as RFID, NFC, Bluetooth™ BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The monitoring system 408 may be associated with and optionally controlled by one or more entities such as a business, corporation, individual, partnership, or any other entity that provides one or more of goods, services, and consultations to individuals such as customers. In some embodiments, the monitoring system 408 may be controlled by a third party on behalf of another business, corporation, individual, partnership. The monitoring system 408 may include one or more servers and computer systems for performing one or more functions associated with products and/or services that the organization provides.

Web server 410 may include a computer system configured to generate and provide one or more websites accessible to customers, as well as any other individuals involved in accessing monitoring system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the prediction system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the monitoring system 408 to interact with one another and to connect to the network 406 for interacting with components in the system 400 environment. In some embodiments, the local network 412 may include an interface for communicating with or linking to the network 406. In other embodiments, certain components of the monitoring system 408 may communicate via the network 406, without a separate local network 406.

The monitoring system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access monitoring system 408 using the cloud computing environment. User device 402 may be able to access monitoring system 408 using specialized software. The cloud computing environment may eliminate the need to install specialized software on user device 402.

In accordance with certain example implementations of the disclosed technology, the monitoring system 408 may include one or more computer systems configured to compile data from a plurality of sources, such as the prediction system 320, web server 410, and/or the database 416, for example. The prediction system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### Example Use Case

The following example use case describes an example of a typical user flow pattern. This section is intended solely for explanatory purposes and not in limitation.

In one example, a customer may pay for a meal in a restaurant. The merchant may process the customer's meal ticket using the customer's provided credit card. After the initial payment has gone through, the customer may write in a tip or gratuity amount on the paper receipt and provide the paper receipt back to the merchant. The financial institution associated with the customer's credit card may track the customer's day-to-day transactions such that the financial institution sees when the initial charge for the customer's meal comes through into the customer's account. The financial institution may utilize a trained MLM to determine whether this initial charge is one that seems indicative of a post-transaction adjustment coming through at a later time. The trained MLM may look through the user's past transaction history to see when the user may have visited this merchant, or other similar merchants, and if so, whether any post-transaction adjustments were made to those corresponding transactions. The MLM may also look at the merchant's name or MCC corresponding to the transaction to determine this type of transaction is likely from food and/or drinks at a restaurant, and thus the type of transaction that a customer would typically leave a tip.

At this point, a system associated with the financial institution may be configured to send the customer a notification, e.g., a push-notification to the user's phone via a mobile application, prompting the user to confirm this transaction will indeed include a corresponding PTA, and to enter what PTA value (e.g., dollar amount) the customer left for the merchant (a first PTA). The system may then receive a response to the push notification, wherein the user may confirm that she left a $20.00 tip for the merchant. The system may then monitor transactions coming through on the customer's account to determine if and when the initial transaction is adjusted with a second PTA from the merchant. Once the system recognizes the transaction has been adjusted with a second PTA, the system may determine whether the first and second PTAs match at least within a predetermined threshold of each other. The system may assign the predetermined threshold as a percentage range based on other tip amounts the customer has historically left at the same or similar merchants. If the system determines the first and second PTAs match, the system may confirm the transaction for the initial amount plus the second PTA. The system may further modify the GUI of the user's mobile device via the mobile application to generate a modified GUI that includes a confirmation indication, e.g., a green flag, placed proximate the transaction line in the user's posted transaction history.

Alternatively, in some embodiments where the system determines the first and second PTAs do not match at least within the predetermined threshold, the system may instead initiate one or more fraud prevention actions, such as notifying the merchant to verify the second PTA, and/or notifying the customer to determine whether the customer wishes to dispute the final transaction amount.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive data associated with a transaction conducted by a user; determine, using a first machine learning model (MLM) and based on one or more factors, whether the transaction is indicative of a post-transaction event; responsive to determining the transaction is indicative of the post-transaction event, cause a user device associated with the user to display a first notification, via a graphical user interface (GUI), to prompt the user to confirm that the post-transaction event occurred and to enter a first post-transaction amount associated with the post-transaction event; receive, from the user via the GUI, a confirmation that the post-transaction event occurred and the first post-transaction amount; monitor the data associated with the transaction to determine whether the data has been updated to include a second post-transaction amount; responsive to determining the data has been updated to include the second post-transaction amount, determine whether the first and second post-transaction amounts match; responsive to determining the first and second post-transaction amounts match: confirm the transaction; modify the GUI to generate a first modified GUI comprising a confirmation indication; and cause the user device to display the confirmation indication; and responsive to determining the first and second post-transaction amounts do not match, initiate one or more fraud prevention actions.

Clause 2: The system of clause 1, wherein the one or more factors comprise transaction history, entity classification, entity type, geographic location, time of day, or combinations thereof.

Clause 3: The system of clause 1, wherein the instructions are further configured to cause the system to: responsive to determining the first and second post-transaction amounts do not match, cause the user device associated with the user to display a second notification, via the GUI, to request the user confirm the second post-transaction amount; receive, from the user via the GUI, an indication that the second post-transaction amount is incorrect; modify the GUI to generate a second modified GUI comprising an incorrect confirmation indication; and cause the user device to display the incorrect confirmation indication associated with the first and second post-transaction amounts, wherein initiating the one or more fraud prevention actions is based on receiving the indication.

Clause 4: The system of clause 1, wherein the one or more fraud prevention actions comprise: transmitting a second notification to an entity associated with the transaction; and causing the user device associated with the user to display a third notification, via the GUI, to request whether the user would like to dispute the transaction.

Clause 5: The system of clause 4, wherein the second notification is configured to enable the entity to adjust the second post-transaction amount.

Clause 6: The system of clause 4, wherein the instructions are further configured to cause the system to: receive a response to the third notification, the response indicating the user would like to dispute the transaction; and responsive to receiving the response: modify the GUI to generate a second modified GUI comprising a disputed indication; and cause the user device to display the disputed indication.

Clause 7: The system of clause 1, wherein the instructions are further configured to cause the system to: determine, using a second MLM and based on the one or more factors, whether the first post-transaction amount exceeds a predetermined threshold; and responsive to determining the first post-transaction amount exceeds the predetermined threshold, cause the user device associated with the user to display a second notification, via the GUI, indicating the first post-transaction amount may be higher than the user desires.

Clause 8: The system of clause 1, wherein the instructions are further configured to cause the system to: receive, from the user via the GUI, a request to monitor the transaction.

Clause 9: A system comprising: one or more processors; and a memory in communication with the one or more processors and storing instructions that, when executed by the one or more processors, are configured to cause the system to: receive data associated with a transaction conducted by a user; determine, using a first machine learning model (MLM) and based on one or more factors, whether the transaction is indicative of a post-transaction event; responsive to determining the transaction is indicative of the post-transaction event, cause a user device associated with the user to display a first notification, via a graphical user interface (GUI), to prompt the user to confirm the post-transaction event occurred; receive, from the user via the GUI, a confirmation that the post-transaction event occurred; responsive to receiving the confirmation that the post-transaction event occurred, determine, using a second MLM and based on the one or more factors, a first post-transaction amount associated with the post-transaction event; monitor the data associated with the transaction to determine whether the data has been updated to include a second post-transaction amount; responsive to determining the data has been updated to include the second post-transaction amount, determine whether the second post-transaction amount matches the first post-transaction amount within a predetermined threshold; responsive to determining the second post-transaction amount matches the first post-transaction amount within the predetermined threshold: confirm the transaction; modify the GUI to generate a first modified GUI comprising a confirmation indication; and cause the user device to display the confirmation indication; and responsive to determining the second post-transaction amount does not match the first post-transaction amount within the predetermined threshold, cause the user device associated with the user to display a second notification, via the GUI, to prompt the user to confirm the second post-transaction amount.

Clause 10: The system of clause 9, wherein the one or more factors comprise transaction history, entity classification, entity type, geographic location, time of day, or combinations thereof.

Clause 11: The system of clause 9, wherein the predetermined threshold comprises a percentage range.

Clause 12: The system of clause 9, wherein the instructions are further configured to cause the system to: receive, from the user via the GUI, a first response to the second notification, the first response indicating the second post-transaction amount is incorrect; modify the GUI to generate a second modified GUI comprising an incorrect confirmation indication; cause the user device to display the incorrect confirmation indication associated with the first and second post-transaction amounts; and responsive to receiving the first response, initiate one or more fraud prevention actions.

Clause 13: The system of clause 12, wherein the one or more fraud prevention actions comprise: transmitting a third notification to an entity associated with the transaction; and causing the user device associated with the user to display a fourth notification, via the GUI, to request whether the user would like to dispute the transaction.

Clause 14: The system of clause 13, wherein the third notification is configured to enable the entity to adjust the second post-transaction amount.

Clause 15: The system of clause 13, wherein the instructions are further configured to cause the system to: receive, from the user via the GUI, a second response to the fourth notification, the second response indicating the user would like to dispute the transaction; and responsive to receiving the second response: modify the GUI to generate a third modified GUI comprising a disputed indication; and cause the user device to display the third modified GUI.

Clause 16: A system comprising: one or more processors; and a memory in communication with the one or more processors and storing instructions that, when executed by the one or more processors, are configured to cause the system to: receive data associated with a transaction conducted by a user; determine, using a first machine learning model (MLM) and based on one or more factors, that the transaction is indicative of a post-transaction event; responsive to determining the transaction is indicative of the post-transaction event, cause a user device associated with the user to display a first notification, via a graphical user interface (GUI), to prompt the user to confirm the post-transaction event occurred; receive, from the user via the GUI, a confirmation that the post-transaction event occurred; responsive to receiving the confirmation that the post-transaction event occurred, determine, using a second MLM and based on the one or more factors, a first post-transaction amount associated with the post-transaction event; monitor the data associated with the transaction to determine whether the data has been updated to include a second post-transaction amount; responsive to determining the data has been updated to include the second post-transaction amount, cause the user device associated with the user to display a second notification, via the GUI, to prompt the user to confirm the second post-transaction amount; receive, from the user via the GUI, a first indication that the second post-transaction amount is correct; responsive to receiving the first indication: confirm the transaction; modify the GUI to generate a first modified GUI comprising a confirmation indication; and cause the user device to display the confirmation indication; receive, from the user via the GUI, a second indication that the second post-transaction amount is incorrect; and responsive to receiving the second indication, initiate one or more fraud prevention actions.

Clause 17: The system of clause 16, wherein the one or more factors comprise transaction history, entity classification, entity type, geographic location, time of day, or combinations thereof.

Clause 18: The system of clause 16, wherein the one or more fraud prevention actions comprise: transmitting a third notification to an entity associated with the transaction; and causing the user device associated with the user to display a fourth notification, via the GUI, to request whether the user would like to dispute the transaction.

Clause 19: The system of clause 18, wherein the third notification is configured to enable the entity to adjust the second post-transaction amount.

Clause 20: The system of clause 18, wherein the instructions are further configured to cause the system to: receive, from the user via the GUI, a response to the fourth notification, the response indicating the user would like to dispute the transaction; and responsive to receiving the response; modify the GUI to generate a second modified GUI comprising a disputed indication; and cause the user device to display the disputed indication.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive data associated with a transaction conducted by a user;
determine, using a first machine learning model (MLM) and based on one or more factors, whether the transaction is indicative of a post-transaction event;
responsive to determining the transaction is indicative of the post-transaction event, cause a user device associated with the user to display a first notification, via a graphical user interface (GUI), to prompt the user to confirm that the post-transaction event occurred and to enter a first post-transaction amount associated with the post-transaction event;
receive, from the user via the GUI, a confirmation that the post-transaction event occurred and the first post-transaction amount;
monitor the data associated with the transaction to determine whether the data has been updated to include a second post-transaction amount;
responsive to determining the data has been updated to include the second post-transaction amount, determine whether the first and second post-transaction amounts match;
responsive to determining the first and second post-transaction amounts match:
confirm the transaction;
modify the GUI to generate a first modified GUI comprising a confirmation indication; and
cause the user device to display the confirmation indication; and
responsive to determining the first and second post-transaction amounts do not match, initiate one or more fraud prevention actions.

2. The system of claim 1, wherein the one or more factors comprise transaction history, entity classification, entity type, geographic location, time of day, or combinations thereof.

3. The system of claim 1, wherein the instructions are further configured to cause the system to:
responsive to determining the first and second post-transaction amounts do not match, cause the user device associated with the user to display a second notification, via the GUI, to request the user confirm the second post-transaction amount;
receive, from the user via the GUI, an indication that the second post-transaction amount is incorrect;
modify the GUI to generate a second modified GUI comprising an incorrect confirmation indication; and
cause the user device to display the incorrect confirmation indication associated with the first and second post-transaction amounts,
wherein initiating the one or more fraud prevention actions is based on receiving the indication.

4. The system of claim 1, wherein the one or more fraud prevention actions comprise:
transmitting a second notification to an entity associated with the transaction; and
causing the user device associated with the user to display a third notification, via the GUI, to request whether the user would like to dispute the transaction.

5. The system of claim 4, wherein the second notification is configured to enable the entity to adjust the second post-transaction amount.

6. The system of claim 4, wherein the instructions are further configured to cause the system to:
receive a response to the third notification, the response indicating the user would like to dispute the transaction; and
responsive to receiving the response:
modify the GUI to generate a second modified GUI comprising a disputed indication; and
cause the user device to display the disputed indication.

7. The system of claim 1, wherein the instructions are further configured to cause the system to:
determine, using a second MLM and based on the one or more factors, whether the first post-transaction amount exceeds a predetermined threshold; and
responsive to determining the first post-transaction amount exceeds the predetermined threshold, cause the user device associated with the user to display a second notification, via the GUI, indicating the first post-transaction amount may be higher than the user desires.

8. The system of claim 1, wherein the instructions are further configured to cause the system to:
receive, from the user via the GUI, a request to monitor the transaction.

9. A system comprising:
one or more processors; and
a memory in communication with the one or more processors and storing instructions that, when executed by the one or more processors, are configured to cause the system to:
receive data associated with a transaction conducted by a user;
determine, using a first machine learning model (MLM) and based on one or more factors, whether the transaction is indicative of a post-transaction event;
responsive to determining the transaction is indicative of the post-transaction event, cause a user device associated with the user to display a first notification, via a graphical user interface (GUI), to prompt the user to confirm the post-transaction event occurred;
receive, from the user via the GUI, a confirmation that the post-transaction event occurred;
responsive to receiving the confirmation that the post-transaction event occurred, determine, using a second MLM and based on the one or more factors, a first post-transaction amount associated with the post-transaction event;
monitor the data associated with the transaction to determine whether the data has been updated to include a second post-transaction amount;
responsive to determining the data has been updated to include the second post-transaction amount, determine whether the second post-transaction amount matches the first post-transaction amount within a predetermined threshold;
responsive to determining the second post-transaction amount matches the first post-transaction amount within the predetermined threshold:
confirm the transaction;
modify the GUI to generate a first modified GUI comprising a confirmation indication; and
cause the user device to display the confirmation indication; and
responsive to determining the second post-transaction amount does not match the first post-transaction amount within the predetermined threshold, cause the user device associated with the user to display a second notification, via the GUI, to prompt the user to confirm the second post-transaction amount.

10. The system of claim 9, wherein the one or more factors comprise transaction history, entity classification, entity type, geographic location, time of day, or combinations thereof.

11. The system of claim 9, wherein the predetermined threshold comprises a percentage range.

12. The system of claim 9, wherein the instructions are further configured to cause the system to:
receive, from the user via the GUI, a first response to the second notification, the first response indicating the second post-transaction amount is incorrect;
modify the GUI to generate a second modified GUI comprising an incorrect confirmation indication;
cause the user device to display the incorrect confirmation indication associated with the first and second post-transaction amounts; and
responsive to receiving the first response, initiate one or more fraud prevention actions.

13. The system of claim 12, wherein the one or more fraud prevention actions comprise:
transmitting a third notification to an entity associated with the transaction; and
causing the user device associated with the user to display a fourth notification, via the GUI, to request whether the user would like to dispute the transaction.

14. The system of claim 13, wherein the third notification is configured to enable the entity to adjust the second post-transaction amount.

15. The system of claim 13, wherein the instructions are further configured to cause the system to:
receive, from the user via the GUI, a second response to the fourth notification, the second response indicating the user would like to dispute the transaction; and
responsive to receiving the second response:
modify the GUI to generate a third modified GUI comprising a disputed indication; and
cause the user device to display the third modified GUI.

16. A system comprising:
one or more processors; and
a memory in communication with the one or more processors and storing instructions that, when executed by the one or more processors, are configured to cause the system to:
receive data associated with a transaction conducted by a user;
determine, using a first machine learning model (MLM) and based on one or more factors, that the transaction is indicative of a post-transaction event;
responsive to determining the transaction is indicative of the post-transaction event, cause a user device associated with the user to display a first notification, via a graphical user interface (GUI), to prompt the user to confirm the post-transaction event occurred;
receive, from the user via the GUI, a confirmation that the post-transaction event occurred;
responsive to receiving the confirmation that the post-transaction event occurred, determine, using a second MLM and based on the one or more factors, a first post-transaction amount associated with the post-transaction event;
monitor the data associated with the transaction to determine whether the data has been updated to include a second post-transaction amount;
responsive to determining the data has been updated to include the second post-transaction amount, cause the user device associated with the user to display a second notification, via the GUI, to prompt the user to confirm the second post-transaction amount;
receive, from the user via the GUI, a first indication that the second post-transaction amount is correct;
responsive to receiving the first indication:
confirm the transaction;
modify the GUI to generate a first modified GUI comprising a confirmation indication; and
cause the user device to display the confirmation indication;
receive, from the user via the GUI, a second indication that the second post-transaction amount is incorrect; and
responsive to receiving the second indication, initiate one or more fraud prevention actions.

17. The system of claim 16, wherein the one or more factors comprise transaction history, entity classification, entity type, geographic location, time of day, or combinations thereof.

18. The system of claim 16, wherein the one or more fraud prevention actions comprise:
transmitting a third notification to an entity associated with the transaction; and
causing the user device associated with the user to display a fourth notification, via the GUI, to request whether the user would like to dispute the transaction.

19. The system of claim 18, wherein the third notification is configured to enable the entity to adjust the second post-transaction amount.

20. The system of claim 18, wherein the instructions are further configured to cause the system to:
receive, from the user via the GUI, a response to the fourth notification, the response indicating the user would like to dispute the transaction; and
responsive to receiving the response;
modify the GUI to generate a second modified GUI comprising a disputed indication; and
cause the user device to display the disputed indication.
